(19) United States
(12) Patent Application Publication
(10) Pub. No.: US 2009/0293329 A1
(43) Pub. Date: Dec. 3, 2009

(54) SCREEN DEVICE HAVING A SIDE ILLUMINATION PROCESS

(76) Inventor: Kyung-Hee Kim, Gyeonggi-do (KR)

Correspondence Address: BERLINER & ASSOCIATES, 555 WEST FIFTH STREET, 31ST FLOOR, LOS ANGELES, CA, 90013, US

(21) Appl. No.: 12/374,699

(22) PCT Filed: Jul. 26, 2007
(86) PCT No.: PCT/KR2007/003580

§ 371 Date: Apr. 16, 2009

(30) Foreign Application Priority Data
Jul. 26, 2006 (KR) 10-2006-0070125
Nov. 14, 2006 (KR) 10-2006-0112019

(51) Int. Cl. G09F 13/18

(52) U.S. Cl. 40/442

(57) ABSTRACT

The present invention relates to a screen device capable of producing a dynamic screen effect in a screen device of a side sectional illumination method. In a configuration for the dynamic screen effect, a transparent material flat board fragment set (1, 1′) is configured in one flat surface of a set of transparent material flat board fragments (22). An image (2) is arranged in one side flat surface of the transparent material flat board fragment set (1, 1′). In a lower-end side section, an illuminating light device (3) is configured such that a controller (4) controls a light turn-on sequence and a hue variation sequence. In another configuration, a backside screen (V) is attached to the backside of the transparent material flat board fragment set (1, 1′) and the illuminating light device (3) is configured to be controlled by the controller (4) in the lower-end side section. In a further configuration, an overall backside of the transparent material flat board fragment set (1, 1′) is configured to be surface-emitting, a diffuse-reflection sheet (9) is configured behind the surface-emitting surface, and a light transmission material screen (7) is configured in a front side of the transparent material flat board fragment set (1, 1′). When the controller controls the illuminating light device to be turned on, a screen is produced with a dynamic feeling that an illuminated portion of the screen or image moves.

### TECHNICAL FIELD

The present invention relates to a screen device capable of producing a dynamic screen effect in a state in which a fixed screen is installed in a screen device using a side sectional illumination method.

The present invention is aimed to provide a screen device that can produce a dynamic screen effect in a state in which a fixed screen is installed in a screen device of a side sectional illumination method.

### BACKGROUND ART

One of screen devices of a conventional side sectional illumination method is configured by fragmenting an image designed with a character or pattern on one side flat board surface of a transparent material or printing the image from which light is emitted on the flat board surface to form an image portion of the transparent material flat board and installing an illuminating light device in a side section portion of the transparent material flat board on which the image is printed or fragmented.

In one of other conventional technologies, a plurality of white dots of a small area having different sizes according to positions on one side surface of a transparent material flat board are printed on the overall surface of one side. Alternatively, fragment lines fragmented with a plurality of V-shaped groove lines are arranged across the overall flat surface, and light is emitted on the overall flat surface at a uniform illuminance by changing an interval between lines fragmented with the V-shaped grooves according to positions. A diffuse-reflection sheet is installed on the backside of a printed or fragmented portion of a transparent flat board and an illuminating light is installed and configured in one side section of the transparent material flat board. This conventional screen device is characterized in that a thickness may be thin and the overall screen may be illuminated at the uniform illuminance using the side sectional illumination method.

In these conventional technologies, there is a well-known theory that light is emitted from an image portion by externally diffuse-reflecting the light on a fragmented image portion or a printed image portion arranged on a transparent material flat board surface according to illuminating light incoming from a side section of a transparent material flat board. That is, the theory is used to emit the light outside the transparent material flat board without totally-reflecting the light from the fragmented surface or the printed surface in the fragmented image portion or the printed image portion interfering with the total reflection of light when the light incoming from the side section of the transparent material flat board is totally-reflected and travels inside the transparent material flat board.

The conventional technologies are disadvantageous in that the effect of attracting public eye is insufficient at the time of use in an advertising screen device since a picture (or image) expressed on a screen is illuminated only in a static or stopped state.

In the conventional technologies, an illuminating light device uses an illuminating light device (for example, cold cathode fluorescent light (CCFL)) having a short diameter or a light emitting diode (LED) array in which a plurality of LEDs are arrayed. When the illuminating light device configured with the LED array is used, the LEDs arranged on a hue-by-hue basis are controlled by a controller. In the case of variable color LEDs, a light-emission color of an LED is controlled according to signal of the controller, and all LEDs are configured to flash and illuminate so as to attract the public eye.

In another conventional technology, two or more transparent material flat board screen devices in which an illuminating light device is installed in a side section are configured to be overlapped with each other. Image parts are arranged on the respective transparent material flat boards. As viewed from the front side, the respective image parts arranged on the multiple transparent flat boards are combined to substantially create one combined image. A controller controls illuminating lights illuminating the respective transparent material flat boards. Consequently, multiple screens may be produced. There is a drawback in that the conventional technology for producing the multiple screens may not give a dynamic feeling as in the present invention where an illumination variation dynamically moves on the screen.

### DISCLOSURE OF INVENTION

### Technical Problem

The present invention has been made to solve the foregoing problems with the prior art, and therefore an object of the present invention is to provide a screen device having a dynamic screen effect as if a screen moves to the left and right in a screen device of a side sectional illumination method without an electric bulb like an electric sign.

To realize the above object, a method using a transparent material flat board is proposed. Another object to be realized is to provide a screen device that can give a dynamic feeling with a side sectional illumination method using a transparent material flat board including an air layer. A further object of the present invention is to provide a screen device in which a stationary image can be expressed as in a conventional electric sign and a dynamic effect can be produced with a background screen of the stationary image in a screen device of a side sectional illumination method.

### Technical Solution

As an aspect of the present invention for realizing the above object, there is provided a screen device of a side sectional illumination method for producing an image emitting effect in a transparent material flat board screen device in which an illuminating light is installed in a side section of transparent acrylic and an image is arranged on a flat surface portion of the transparent acrylic, including: a transparent material flat board fragment set configured with a set of transparent material flat board fragments having a regular width; an LED array installed and configured such that a controller configured with a microcomputer in one side section portion of the transparent material flat board fragment set controls a light turn-on sequence and/or a hue variation sequence based on content programmed in advance, the LED array being configured with a plurality of LEDs in the side section portion located in a direction perpendicularly meeting fragment separation lines for separating the transparent material flat board fragments of the transparent material flat board fragment set; a portion of an image from which light is emitted is arranged and configured on one side flat surface of the transparent material flat board fragment set using one of a printing method, a mechanical sculpturing method, and a method of attaching a color sheet on which a transparent adhesive is coated; and a case (for example, a base) in which the LED array and the controller are embedded, the case supporting and fixing the transparent material flat board fragment set, whereby the effect is produced as if the portion of the image from which the light is emitted moves by controlling the light turn-on sequence and/or the hue variation sequence of the LED array.

As an aspect of the present invention for realizing the above object, there is provided a screen device of a side sectional illumination method for producing an image emitting effect in a transparent material flat board screen device in which an illuminating light is installed in a side section of transparent acrylic and an image is arranged on a flat surface portion of the transparent acrylic, including: a transparent material flat board fragment set configured with a set of transparent material flat board fragments having a regular width; an LED array installed and configured such that a controller configured with a microcomputer in one side section portion of the transparent material flat board fragment set controls a light turn-on sequence and/or a hue variation sequence based on content programmed in advance, the LED array being configured with a plurality of LEDs in the side section portion located in a direction perpendicularly meeting fragment separation lines for separating the transparent material flat board fragments of the transparent material flat board fragment set, an overall surface of each transparent material flat board fragment of the transparent material flat board fragment set being configured to be surface-emitting in one side flat surface of the transparent material flat board fragment set using one of a printing method, a mechanical sculpturing method, and a method of attaching a color sheet on which a transparent adhesive is coated; a reflection sheet installed and configured in the backside of a surface-emitting portion; a screen printed on a light transmission material in the front portion of the transparent material flat board fragment set; and a case (for example, a base) in which the LED array and the controller are embedded, the case supporting and fixing the transparent material flat board fragment set and the screen, wherein light emissions of the surface-emitting transparent material flat board fragments of the transparent material flat board fragment set are controlled in a programmed sequence, such that the effect is produced as if a portion illuminated on the screen installed in the overall surface of the transparent material flat board fragment set moves.

As an aspect of the present invention for realizing the above object, there is provided a screen device of a side sectional illumination method for producing an image emitting effect in a transparent material flat board screen device in which an illuminating light is installed in a side section of transparent acrylic and an image is arranged on a flat surface portion of the transparent acrylic, including: a transparent material flat board fragment set configured with a set of transparent material flat board fragments having a regular width; an LED array installed and configured such that a controller configured with a microcomputer in one side section portion of the transparent material flat board fragment set controls a light turn-on sequence and/or a hue variation sequence based on content programmed in advance, the LED array being configured with a plurality of LEDs in the side section portion located in a direction perpendicularly meeting fragment separation lines for separating the transparent material flat board fragments of the transparent material flat board fragment set, a backside screen printed to be attached to the backside flat surface of the transparent material flat board fragment set attached using a transparent adhesive in a state in which an air layer is excluded, a printed portion of the backside screen being configured to be attached to the backside of the transparent material flat board fragment set; and a case (for example, base) in which the LED array and the controller are embedded, the case supporting and fixing the transparent material flat board fragment set, wherein the dynamic effect is produced as if a light-emitting portion of the backside screen attached to the backside of the transparent material flat board fragment set moves when the controller controls the LED array.

As an aspect of the present invention for realizing the above object, there is provided a screen device of a side sectional illumination method for producing an image emitting effect in a transparent material flat board screen device in which an illuminating light is installed in a side section of transparent acrylic and an image is arranged on a flat surface portion of the transparent acrylic, including: a transparent material flat board fragment set configured by installing a plurality of space separation partition walls having a function of limiting illuminating light within respective spaces at regular intervals in a transparent material flat board configured with an air layer of a n empty space formed by a backside reflection wall installed to be in parallel with a plate of a screen-supporting transparent acrylic on which a screen of a light transmission material is installed and the screen or to be inclined; an illuminating light device configured with a lens-type LED array for radiating converging light in a front side portion in which a convex lens is configured in one side section portion of the transparent material flat board fragment set configured with the empty-space air layer located in a direction perpendicularly meeting the plurality of space separation partition walls, the lens-type LED arrays being configured such that a controller controls a light turn-on sequence and/or a hue sequence; and a case (for example, base) in which the LED array and the controller are embedded, the case supporting and fixing the screen and the backside reflection wall, wherein the light is dispersed while the converging light radiated from the LED array is repeatedly reflected between the backside of the screen and the backside reflection wall and is repeatedly transmitted to the screen, and simultaneously a portion illuminated on the screen moves when the controller controls an illumination sequence of the respective spaces.

As an aspect of the present invention for realizing the above object, there is provided a screen device of a side sectional illumination method for producing an image emitting effect in a transparent material flat board screen device in which an illuminating light is installed in a side section of transparent acrylic, an image is arranged on a flat surface portion of the transparent acrylic, and one screen device is configured by overlapping two transparent acrylic screen devices, including: a transparent material flat board fragment set configured in a form in which a plurality of transparent material flat board fragments are combined; a rear screen device configured using the transparent material flat board fragment set; a front screen device installed and configured to be overlapped with the rear screen device serving as another transparent material flat board screen device on which an image is arranged in front of the rear screen device, an image of the front screen device being arranged and configured in one of a printing method, a mechanical sculpturing method, and a method of attaching a color sheet on which a transparent adhesive is coated; a screen means of the rear screen device configured with one screen device of one of the devices of claims 1, 2, 3, and 4; illuminating light devices configured with two LED arrays respectively illuminating the rear screen device and the front screen device, the illuminating light devices being installed and configured in a side section in an identical direction of the rear screen device and the front screen device; and a light shield separation wall installed between the two LED arrays to prevent light from illuminating an undesired position, wherein a dynamic screen effect is produced in the rear screen device when a controller controls the illuminating light devices, light of the image of the front screen device is emitted in a single color or a variable color, a case (for example, base) in which the illuminating light devices configured with the two LED arrays and the controller are embedded and the rear screen device and the front screen device are simultaneously supported and fixed, and a new screen is produced by mutually overlapping a background screen serving as a screen of the dynamic effect of the rear screen device behind the image of the front screen device.

### ADVANTAGEOUS EFFECTS

According to the present invention as set forth above, a screen device of a side sectional illumination method having a fixed screen can produce a dynamic screen moving as if water is flowing.

Moreover, the screen device of the side sectional illumination method can produce a dynamic screen effect that a background screen moves behind a fixed image as if water is flowing.

### BRIEF DESCRIPTION OF THE DRAWINGS

FIG. 1 is a side sectional view showing an example of a screen device of the present invention in which a character or pattern is arranged in a sculpturing method or printing method on one side flat surface of a transparent material flat board fragment set;

FIG. 2 is a cross-sectional view seen from a front side, showing an example of a screen device of the present invention in which a character or pattern is arranged in a sculpturing method or printing method on one side flat surface of a transparent material flat board fragment set;

FIGS. 3 to 6 are front views of a screen portion showing a state produced in the screen portion of FIG. 1 when illuminating lights are controlled to be turned on in a direction from the left to the right;

FIG. 7 is a perspective view showing main parts in a configuration in which a screen of a light transmission material, on which a visual image is printed, is arranged in a front side and a transparent material flat board fragment set is arranged in the backside of the screen, wherein an overall backside of the transparent material flat board fragment set is surface-emitting;

FIG. 8 is a side sectional view showing a configuration in which a screen of a light transmission material, on which a visual image is printed, is arranged in a front side and a transparent material flat board fragment set is arranged in the backside of the screen, wherein an overall backside of the transparent material flat board fragment set is surface-emitting;

FIGS. 9 to 12 are front views of main parts showing a variation of a surface-emitting state of a transparent material flat board fragment set when illuminating lights are controlled to be turned on in a direction from the left to the right;

FIG. 13 is a side sectional view showing an example in which a screen on which a visual image is printed is attached to the backside of a transparent material flat board fragment set using an adhesive coated in a state in which an air layer is excluded;

FIG. 14 is a side sectional view showing an example of another configuration in which a transparent material flat board fragment set is configured with a space separation partition wall (or separation wall) and an air layer according to the present invention (when a backside reflection wall and a screen are configured in parallel);

FIG. 15 is a side sectional view showing an example of another configuration in which the fragment set of the transparent material flat board is configured with a space separation partition wall (or separation wall) and an air layer according to the present invention (when a backside reflection wall is inclined close to the screen in an upward direction);

FIG. 16 is a plan sectional view of FIG. 14;

FIG. 17 is a perspective view showing main parts of FIG. 14;

FIG. 18 is a side sectional view showing an example of a configuration in which another screen device of a transparent material flat board having an image arranged thereon is overlapped in front of the device of FIG. 1, 7, 13, or 14 according to the present invention;

FIG. 19 is a perspective view of FIG. 18;

FIG. 20 is a plan view showing an example of a transparent material flat board fragment set whose fragments are separately cut and then recombined to form one transparent material flat board fragment set; and

FIG. 21 is a plan view showing an example of another transparent material flat board fragment set configured in a state in which upper and lower portions of the transparent material flat board fragment set are connected to each other according to the present invention.

### BEST MODE FOR CARRYING OUT THE INVENTION

### Embodiment 1

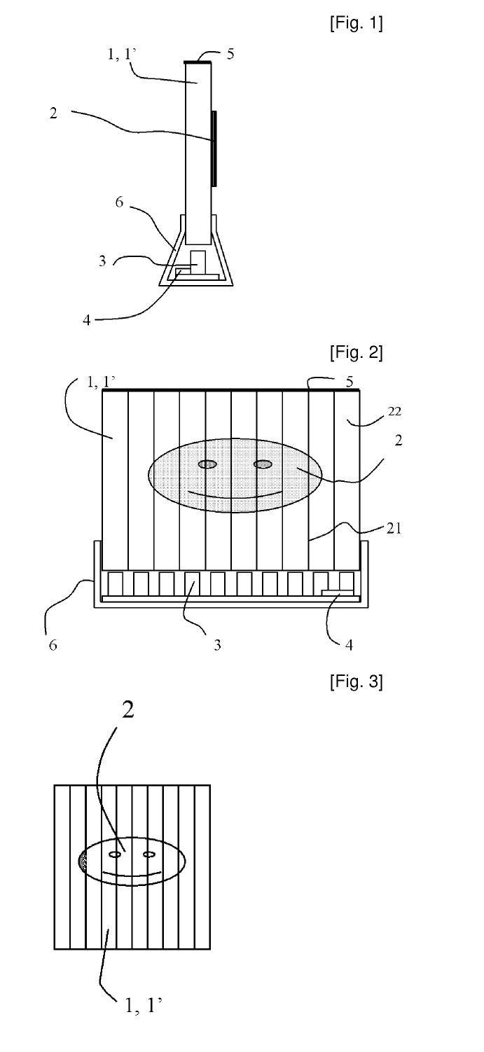

This embodiment is a configuration example in which only a portion of an image 2 designed in the form of a character or pattern is directly printed or sculptured in a mechanical method on one side flat surface portion (front side or backside) of a transparent material flat board fragment set 1, 1′ of FIGS. 1 and 2, or the image 2 is arranged by attaching a color sheet of an image shape on which a transparent adhesive is coated. The configuration of this embodiment will be described in detail with reference to FIGS. 1 to 6.

In FIGS. 1 to 6, the image 2 is arranged on the surface of the front side or backside of the transparent material flat board fragment set 1, 1′. The image 2 is arranged in a printing method, a mechanical sculptured method, or a method of attaching a color sheet on which an adhesive is coated. When the image 2 is arranged on a front side portion of the transparent material flat board fragment set 1, 1′ in the printing method or the attachment method, the image 2 is configured with a light transmission ink or light transmission attachment sheet. In contrast, when the image 2 is arranged on the backside of the transparent material flat board fragment set 1, 1′, an opaque material ink or attachment sheet can be used. An LED array 3 is arranged on a lower-end side section of the transparent material flat board fragment set 1, 1′ on which the image 2 is arranged. The LED array 3 is arranged on a side section portion such that separation lines for separating fragments of the transparent material flat board fragment set 1, 1′ are oriented toward a light arranged on the side section.

A controller 4 configured with a microcomputer controls a light turn-on sequence and a hue variation sequence of the illuminating light device 3 including a plurality of illuminating lights arranged on the side section portion. The illuminating light device 3 can be configured with LEDs. In this case, the illuminating light device 3 is configured with the LED array 3 in which a plurality of LEDs are arrayed. In the case of the illuminating light device configured with the LED array 3, variable color LEDs for emitting light of various colors under the control of the controller 4 can be configured. If the used LED is not a variable color LED, the illuminating light device can be configured by sequentially arranging color LEDs for emitting light of RGB hues. The controller 4 controls the LEDs (or illuminating lights) in a programmed light turn-on sequence or a programmed hue variation sequence. In FIGS. 1 and 2, a base (case) 6 includes the illuminating light device 3 (for example, LED array) unified with the controller 4 embedded therein and simultaneously has a function for supporting and fixing the transparent material flat board fragment set 1, 1′. The transparent material flat board fragment set 1, 1′ used in this embodiment is configured as shown in FIG. 20 or 21. FIG. 20 shows a form in which respective fragments of the transparent material flat board fragment set 1, 1′ are fully separated. FIG. 21 shows a form in which some upper and lower regions of respective transparent material fragments are connected to each other. Since the form of FIG. 21 can be handled in the form of one plate, the external appearance can be beautifully created when the screen device is manufactured and the form can be easily handled at the time of manufacturing.

An operation of this embodiment configured as described above is as follows.

There will be described an example in which the illuminating light device 3 is configured with the LED array 3 in which a plurality of LEDs are arrayed, the LEDs are configured with variable color LEDs, and the image 2 designed in a character of a specific image is arranged as shown in FIG. 2.

In FIGS. 1 and 2, there will be described a programmed example in which illuminating lights designated by the controller 4 are turned on in the illuminating light device 3 installed in a lower-end side section portion of the transparent material flat board fragment set 1, 1′.

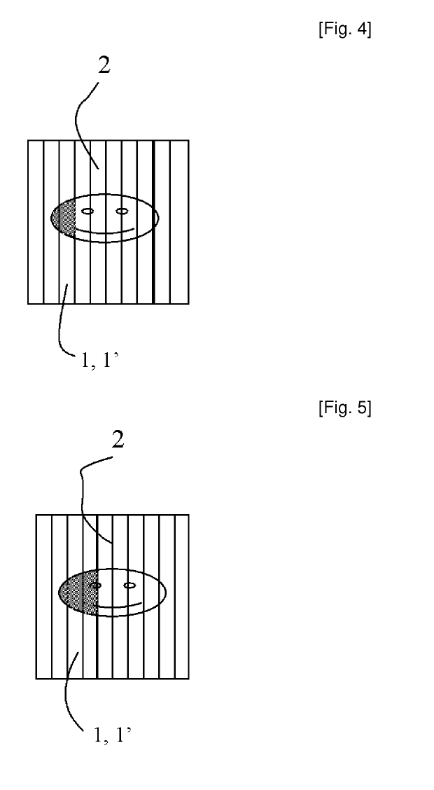

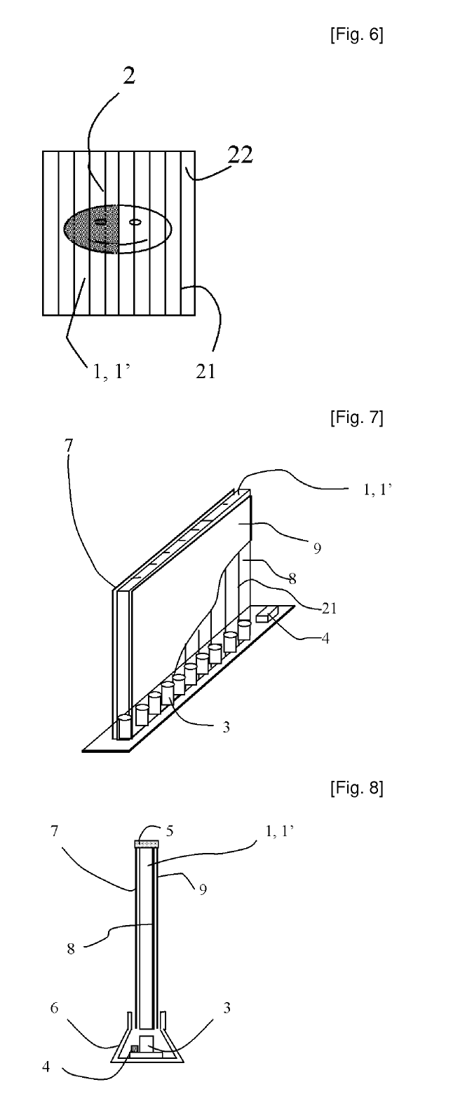

If the controller 4 turns on an illuminating light for illuminating a first transparent material flat board fragment at the beginning from the left of FIG. 2, light is dispersed into only the first transparent material flat board fragment 22 since the respective transparent material flat board fragments 22 are optically separated from each other. However, since the image is not expressed on the first transparent material flat board fragment 22 as shown in FIG. 2, any image 2 is not illuminated and viewed. Subsequently, when the controller 4 additionally turns on an illuminating light for illuminating a second transparent material flat board fragment 22 in a state in which the illuminating light for illuminating the first transparent material flat board fragment 22 has been turned on, only a part of the image 2 displayed on the second transparent material flat board fragment 22 is illuminated and viewed as shown in FIG. 3. Subsequently, when the controller 4 additionally turns on an illuminating light for illuminating a third transparent material flat board fragment 22 in a state in which the illuminating lights for illuminating the first and second transparent material flat board fragments 22 have been turned on, the image 2 displayed on the third transparent material flat board fragment 22 are illuminated and viewed along with the image 2 displayed on the second transparent material flat board fragment 22 as shown in FIG. 4. Subsequently, when the controller 4 additionally turns on an illuminating light for illuminating a fourth transparent material flat board fragment 22 in a state in which the illuminating lights for illuminating the first, second and third transparent material flat board fragments 22 have been turned on, the image 2 displayed on the fourth transparent material flat board fragment 22 is illuminated and viewed along with the image displayed on the second and third transparent material flat board fragments 22 as shown in FIG. 5. Subsequently, when the controller 4 additionally turns on an illuminating light for illuminating a fifth transparent material flat board fragment 22 in a state in which all the illuminating lights for illuminating the first, second, third and fourth transparent material flat board fragments 22 have been turned on, the image 2 displayed on the fifth transparent material flat board fragment 22 is illuminated and viewed along with the image 2 displayed on the second, third and fourth transparent material flat board fragments 22 as shown in FIG. 6. In the same manner, when the transparent material flat board fragments 22 to be illuminated sequentially increase, a part in which the image 2 is illuminated and viewed is moved and enlarged to the right. That is, under the control of the controller 4, a part viewed in the image 2 arranged in the transparent material flat board fragment set 1, 1′ moves in a programmed pattern as if water is flowing. According to a program of the controller 4 configured with a microcomputer, the dynamic effect is produced in various patterns in which a part viewed in the image 2 moves in a direction from the left to the right or from the right to the left, and a part illuminated and viewed in the image 2 moves as if a curtain is opened to the left/right with respect to the center.

In FIGS. 3 to 6, when the device of the present invention is arranged under a bright environment, a non-illuminated image portion next to the illuminated image portion is dark but can be viewed due to ambient light. When the device of the present invention is arranged under a dark environment, only illuminated portions of the image 2 are viewed.

When the controller 4 is configured to control the hue of the illuminating light device 3 configured with variable color LEDs in a programmed sequence, a hue variation form moves and varies. For example, in a state in which all illuminating lights simultaneously illuminate in the blue color, the image 2 exhibits the dynamic effect that a light-emission color varies from the blue color to the red color in the left to right direction when the illuminating lights are sequentially changed to the red color from the illuminating light for illuminating the first transparent material flat board fragment 22. In this case, when the image 2 is configured in the printing method or the sheet attachment method, the white print ink or sheet is configured in the white color, or the colorless printing ink containing a diffuse-reflection material is configured (in a white milk-like color due to diffuse-reflection of ambient natural light).

The surface of a portion of fragment separation lines 21 in which the respective transparent material flat board fragments 22 of the transparent material flat board fragment set 1, 1′ used in the present invention make contact with each other, is very evenly and smoothly processed. Accordingly, in the portion in which the respective transparent material flat board fragments 22 make contact with each other, light is totally-reflected and does not enter an adjacent fragment, such that light is emitted from only image portions arranged on the illuminated transparent material flat board fragments 22. When the surface is not processed to cause light to be totally-reflected in the portion in which the respective transparent material flat board fragments 22 make contact with each other, it is preferable that the light of one transparent material flat board fragment 22 is prevented from entering an adjacent fragment by attaching a light shield sheet (not shown) to a contact surface in contact with the respective transparent material flat board fragments 22.

The reason why light is emitted from a portion of the image 2 is as follows. Since the image 2 is directly printed, attached with a color attachment sheet, or mechanically sculptured on the surface of the transparent material flat board fragment set 1, 1′, illuminating light incoming through a lower-end side section of the transparent material flat board fragment set 1, 1′ is totally-reflected and dispersed into the transparent material flat board fragments 22. But the light is not totally-reflected in a portion in which the image 2 is arranged, such that the light is emitted outside the surface of the transparent material flat board fragments 22. That is, the light is emitted from the portion of the image 2, such that the light is emitted from the image 2 and the image 2 can be viewed. Herein, when the image 2 is configured by attaching the color sheet on which a transparent adhesive is coated, an air layer should be excluded between the flat surface of the transparent material flat board fragments 22 and the attachment sheet. That is, the internal light of the transparent material flat board fragments 22 is externally emitted without total reflection only when the air layer is absent between attachment surfaces, such that the portion of the image 2 is illuminated and viewed.

### Mode for the Invention

### Embodiment 2

This embodiment is an example in which a screen 7 having a picture printed on a light transmission material is additionally installed in a front side portion of a transparent material flat board fragment set 1, 1′ as shown in FIGS. 7 and 8. A configuration of this embodiment will be described in detail with reference to FIGS. 7 and 8.

This embodiment is properly shown in FIGS. 7 and 8. That is, the screen 7 having an image desired to be expressed on the light transmission material is installed in the front side portion of the transparent material flat board fragment set 1, 1′. In a printing method in which white points of a small area are printed across the overall flat surface in the backside of the transparent material flat board fragment set 1, 1′, or a sculpturing method of making a plurality of V-shaped grooves, the backside of the respective transparent material flat board fragments 22 of the transparent material flat board fragment set 1, 1′ are configured to be overall surface-emitting. A reflection sheet 9 is configured such that surface-emitted light is diffuse-reflected to illuminate the screen 7 of the front side portion by arranging the reflection sheet 9 behind a portion in which light is emitted from the printed or sculptured surface. A base (case) 6 containing an illuminating light device 3 embedded therein is installed in a side section portion of a lower end of the transparent material flat board fragment set 1, 1′. The base (case) 6 is configured to support and fix the transparent material flat board fragment set 1, 1′. The controller 4 controls a light turn-on sequence and a light-emission color variation sequence of an illuminating light device 3. The illuminating light device 3 is configured in the side section to illuminate the transparent material flat board fragment set 1, 1′. The illuminating light device 3 can be configured with a plurality of LEDs, and can be configured with LEDs of various hues. When a variable color light is configured, the LEDs are alternately arranged on a color-by-color basis. The variable color light can be realized by alternately arranging, combining and turning on hue-by-hue LEDs one by one. In another method, the illuminating light device 3 is configured with variable color LEDs and the variable color LEDs are controlled by the controller 4 such that variable color illumination is possible. The transparent material flat board fragment set 1, 1′ to be used in this embodiment is configured as shown in FIG. 20 or 21.

An operation of this embodiment configured as described above will be described in detail.

In FIGS. 7 and 8, the backside of the transparent material flat board fragment set 1, 1′ is configured to emit light from the overall area of the backside in the printing method or the sculpturing method. Accordingly, when the light of the illuminating light device 3 installed in the lower-end side section illuminates the transparent material flat board fragment set 1, 1′ in the side section, a part of the illuminating light incoming into the transparent material flat board fragment set 1, 1′ is totally-reflected and dispersed into the respective transparent material flat board fragments 22. A part of the illuminating light is emitted outside the transparent material flat board fragments 22 in the portion printed or the portion sculptured into V-shaped grooves of the fine lines. While the emitted light is diffuse-reflected by the backside diffuse-reflection sheet 9, the light transmission screen 7 installed in the front side portion is uniformly illuminated across the overall area.

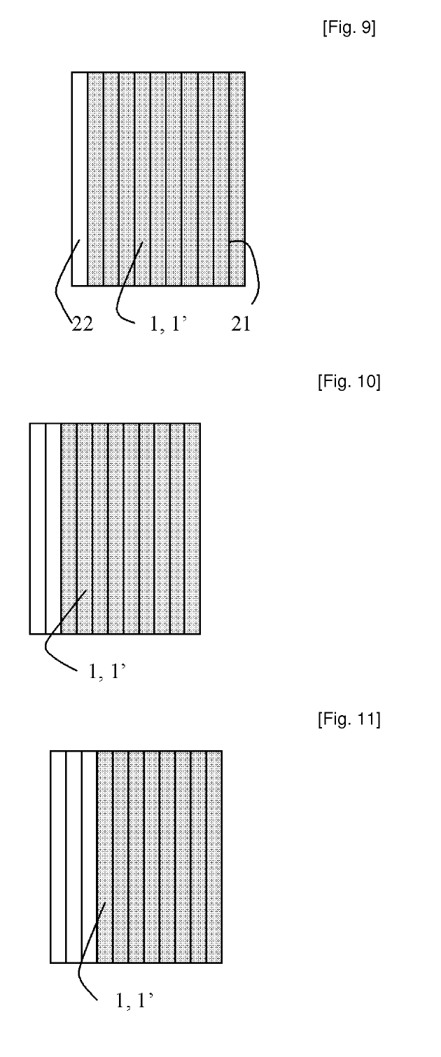

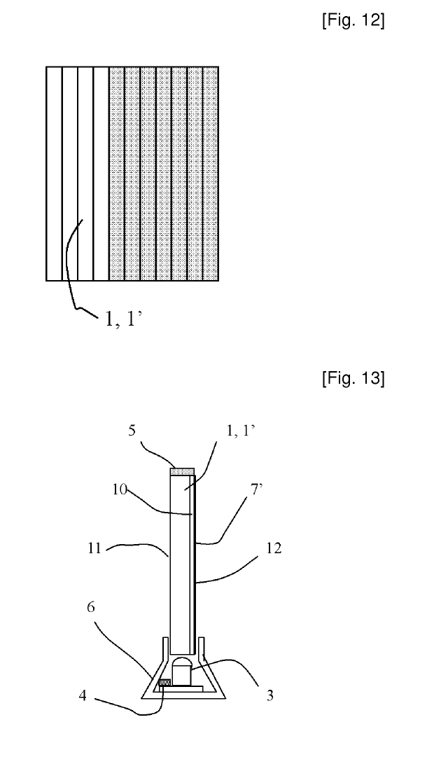

However, in this embodiment, the controller 4 is configured to control a light turn-on sequence and a color variation sequence of the respective illuminating lights located just below the respective transparent material flat board fragments 22. Accordingly, under the control of the controller 4, a turn-on state of the illuminating lights is controlled in a programmed sequence. Consequently, the respective transparent material flat board fragments 22 of the transparent material flat board fragment set 1, 1′ are also surface-emitted in the programmed sequence. FIGS. 9 to 12 show examples in which the respective fragments of the transparent material flat board fragment set 1, 1′ are sequentially surface-emitted. That is, a programmed example in which the illuminating lights are controlled such that surface emission is sequentially made from a first transparent material flat board fragment 22 in FIGS. 9 to 12, is as follows. That is, when an illuminating light for illuminating the first transparent material flat board fragment 22 is turned on, only the first transparent material flat board fragment 22 is surface-emitted as shown in FIG. 9. If illuminating lights for illuminating first and second transparent material flat board fragments 22 are simultaneously turned on, the first and second transparent material flat board fragments 22 are surface-emitted as shown in FIG. 10. If illuminating lights for illuminating first, second and third transparent material flat board fragments 22 are simultaneously turned on, the first, second and third transparent material flat board fragments are surface-emitted as shown in FIG. 11. If illuminating lights for illuminating first, second, third and fourth transparent material flat board fragments 22 are simultaneously turned on, the first, second, third and fourth transparent material flat board fragments 22 are surface-emitted as shown in FIG. 12. That is, when the controller 4 turns on the illuminating lights in a direction from the left to the right as if water is flowing, the respective transparent material flat board fragments 22 of the transparent material flat board fragment set 1, 1′ are surface-emitted as if water is flowing. Therefore, the dynamic effect is felt based on an illumination variation as if a portion in which the light transmission material screen 7 installed in the front side portion of the transparent material flat board fragment set 1, 1′ is brightly illuminated moves in the direction from the left to the right as if water is flowing. When the program of the controller 4 configured with a microcomputer is configured in an illuminating pattern in which various flows are possible, various illumination flow patterns are seen when the screen device of the present invention is viewed from the front side.

### Embodiment 3

This embodiment is another embodiment of the present invention in which the backside attaching screen 7′ is emitted by directly jointing the backside attaching screen 7′ having a printed picture, character or pattern with the flat surface of the backside of a transparent material flat board fragment set 1, 1′ in a state in which an air layer is excluded as shown in FIG. 13. As compared with Embodiment 2, this embodiment is disadvantageous in that a screen cannot be replaced. However, this embodiment has a feature that manufacturing cost is low since a screen printed on a paper can be used when a screen replacement is unnecessary.

This embodiment is configured as shown in FIG. 13. That is, the printed side of the backside attaching screen 7′ is attached to the backside of the transparent material flat board fragment set 1, 1′ using a transparent adhesive 10 coated such that the air layer is excluded. Moreover, an illuminating light device 3 to be controlled by a controller 4 configured with a microcomputer is installed in a lower-end side section portion of the transparent material flat board fragment set 1, 1′ whose backside is attached to the backside attaching screen 7′. A base (case) 6 is installed to contain the illuminating light device 3 embedded therein and support and fix the transparent material flat board fragment set 1, 1′. At this time, it is preferable that the illuminating light device 3 is configured with a lens-type LED array 3 unified with a convex lens in the front side. The reason why the lens-type LED is used is that a large amount of light is dispersed into the transparent material flat board fragments 22 in a state in which the large amount of light converges after light emitted from the LED converges by the convex lens configured in the front side portion of the LED and is incident to the side section of the transparent material flat board fragment set 1, 1′. Accordingly, some light meeting the surface of the transparent material flat board fragments 22 in the light incident to the side section is totally-reflected at the surface of the transparent material flat board fragments 22 and returns to inside of the transparent material flat board fragments 22. Some light incident to the backside attaching screen 7′ in the converging light is emitted from the backside attaching screen 7′ without total reflection. In the converging light, the other light reaches a position far away from the illuminating light device 3 in the form of the converging light. Therefore, the total reflection can be realized, the light can be emitted from the backside attaching screen 7′, and the brightness of the screen from which the light is emitted is as uniform as possible.

The transparent material flat board fragment set 1, 1′ used in this embodiment can be configured such that all the transparent material flat board fragments 22 can be separated as shown in FIG. 20 or some upper and lower regions of the transparent material flat board fragments 22 can be connected to each other as shown in FIG. 21. In the illuminating light device 3 configured with the lens-type LEDs of this embodiment, a space between the LEDs is very narrow and rays of the converging light radiated from the LEDs are overlapped, such that a dark illuminance portion due to an interval between the converging rays does not occur.

An operation of this embodiment is as follows.

When the converging light from the lens-type LEDs in which the convex lens are configured in the front side portion is incoming through the lower-end side section portion of the transparent material flat board fragment set 1, 1′ in FIG. 13, some light of the incoming converging light is repeatedly totally-reflected and dispersed into the transparent material flat board fragments 22 of the transparent material flat board fragment set 1, 1′. Other light of the incoming light is emitted from a junction surface of the backside attaching screen 7′ jointed with the backside (or the right flat surface of FIG. 13) outside the transparent material flat board fragments 22. In this case a printed side of the backside attaching screen 7′ is illuminated, the light from the backside attaching screen 7′ is emitted, and the backside attaching screen 7′ can be viewed. The light reaching the printed side of the backside attaching screen 7′ is diffuse-reflected and a printed picture of the backside attaching screen can be brightly viewed at various viewing angles. That is, the light is totally-reflected on the left flat surface contacting with the air of the transparent material flat board fragments 22 in FIG. 13 and therefore the light is not externally emitted, such that the light returns to inside of the flat board of the transparent material flat board fragments 22. However, most of the light is not totally-reflected on the right flat surface portion attached to the backside attaching screen 7′. The light is emitted from the right surface of the transparent material flat board fragments 22 to the printed side of the backside attaching screen 7′. Accordingly, the emitted light is diffuse-reflected on the printed side of the backside attaching screen 7′. The reason why most of the light is not totally-reflected on the flat surface attached to the backside attaching screen 7′ serving as the right flat surface of FIG. 13 and is emitted to the backside attaching screen 7′ is that a density difference between the transparent material configuring the transparent material flat board fragments 22 and a transparent adhesive 10 attached to the backside attaching screen 7′ is not large. When the density difference between two media is not large, the total reflection does not occur on a contact boundary surface between the two media. Accordingly, after most of the light except light at a large incident angle in the light oriented toward the right flat surface of the transparent material flat board fragments 22 is not totally-reflected and is emitted outside the right flat surface, it looks as if the light is again diffuse-reflected on the printed side of the attached backside attaching screen 7′ and the light of the printed side of the screen 7′ is brightly emitted. As compared with this, the flat surface portion of a front side portion 11 serving as a portion viewed by a viewer of the transparent material flat board fragments 22 corresponding to the left flat surface of FIG. 13 is in contact with the air. Therefore, since a density difference between the medium configuring the transparent material flat board fragments 22 and the air contacting therewith is very large, most of the light on the left flat surface contacting with the air is not emitted outside the transparent medium and is totally-reflected, such that the light returns in a side direction in the transparent material flat board fragments 22. A part of the illuminating light incoming through the lower-end side section of the transparent material flat board fragments 22 is totally-reflected and dispersed into the transparent material flat board fragments 22. As the other light is emitted from the printed portion and is diffuse-reflected, it looks as if the light of the backside attaching screen 7′ jointed with the backside is brightly emitted. This embodiment has a feature that manufacturing cost is low since a cost-effective screen printed on a paper can be mass manufactured.

### Embodiment 4

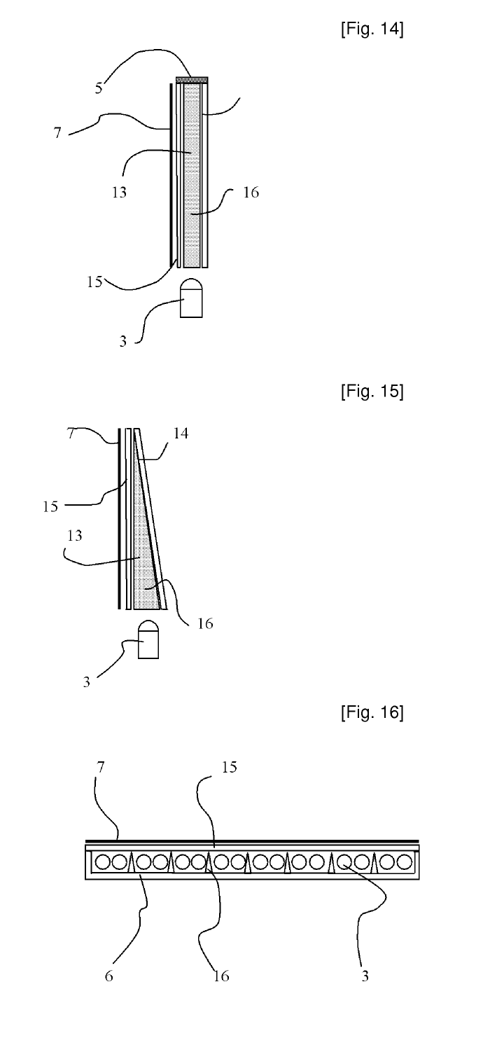

When the transparent material flat board fragment set 1, 1′ is configured as shown in FIGS. 14 to 17, this embodiment is different from the above-described embodiments in that the transparent material flat board fragment set 1, 1′ is not configured with a transparent material such as transparent acrylic whose density is high. That is, this embodiment is another embodiment in which a plurality of space separation partition walls 16 are internally installed and the transparent material flat board fragment set 1, 1′ is configured using an air layer 13 serving as an empty space of a thin thickness formed by a screen 7 and a backside reflection wall 14 as shown in FIGS. 14 to 17.

A configuration of this embodiment is shown in FIGS. 14 to 17.

That is, in FIGS. 14 to 17, the transparent material flat board fragment set 1, 1′ is configured by installing the plurality of space separation partition walls 16 within the air layer 13 of a plate shape of a thin thickness between a screen-supporting transparent acrylic 15 in which the screen 7 is installed in a front side portion and the backside reflection wall 14 installed facing the supporting transparent acrylic 15. An illuminating light device 3 configured with a lens-type LED array 3 is installed in a lower-end side section portion of the transparent material flat board fragment set 1, 1′ configured in the form of the air layer 13 of the empty space of the plate shape. Under control of a controller 4 configured with a microcomputer, a light turn-on sequence and/or a hue variation sequence of the illuminating light device 3 are configured to be controlled. Herein, when the screen device of this embodiment is configured and an additional case 6 is installed, the backside reflection wall 14 can be replaced with the backside flat surface of the case.

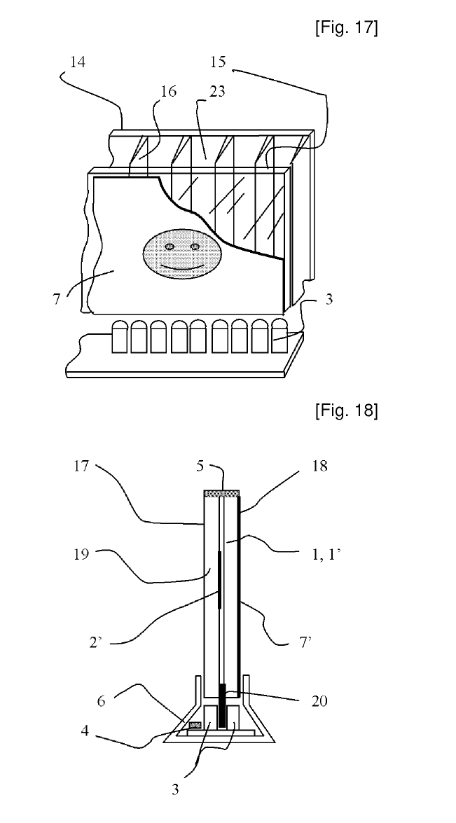

Herein, the case 6 of FIGS. 16 and 17 is configured such that the screen-supporting transparent acrylic 15 on which the screen 7 is installed is installed in an opening portion of one side. A backside reflection wall function can be configured by coating a diffuse-reflection sheet or a white paint on the backside of the case 6. The illuminating light device 3 and the controller 4 can be configured to be embedded in the case 6.

The backside reflection wall 14 can be configured in parallel with the screen 7 as shown in FIG. 14. Alternatively, as the backside reflection wall 14 is far away from lens-type LEDs (that is, in an upward direction), the backside reflection wall 14 can be configured to be inclined close to the screen 7 as shown in FIG. 15. When the backside reflection wall 14 is configured to be inclined as shown in FIG. 15, a larger amount of illuminating light radiated from the side section is reflected to the screen, such that the screen is more brightly illuminated.

The controller 4 configured with a microcomputer controls light turn-on and hue variations of the illuminating light device 3 of this embodiment in a programmed sequence. If a dynamic variation is unnecessary, the space separation partition walls 16 and the controller 4 are not configured. In this case, the overall surface of the screen 7 is configured to be constantly illuminated without a dynamic variation.

An operation of this embodiment is as follows.

In FIGS. 14 and 15, converging light is radiated from lens-type LEDs of the illuminating light device 3 installed in the lower-end side section and is incident into the side section of the transparent material flat board fragment set 1, 1′ serving as the air layer 13 of the empty space of the plate shape of the thin thickness formed by the screen 7, the surface of the screen-supporting transparent acrylic 15, and the backside reflection wall 14. Some light of the incident illuminating light is transmitted from the backside of a light transmission backlight sheet serving as a material configuring the screen 7 and the flat surface of the screen-supporting transparent acrylic 15 for supporting the screen 7 to the front side, thereby illuminating the screen 7. Some light is reflected on the backside of the screen 7 and the surface of the screen-supporting transparent acrylic 15 and is oriented toward the backside reflection wall 14. On the other hand, the light oriented toward the backside reflection wall 14 is reflected thereon and returns to the screen 7. Accordingly, some light oriented toward the backside of the screen 7 is transmitted to a semi-transparent material configuring the screen 7, thereby illuminating the screen 7. The remaining light is reflected on the backside of the screen 7 and the flat surface of the screen-supporting transparent acrylic 15, such that the light returns to the air layer 13 of the empty space and is oriented toward the backside reflection wall 14. The light incident from the side section is repeatedly transmitted and reflected among the backside of the screen 7, the plate surface of the screen-supporting transparent acrylic 15, and the backside reflection wall 14, such that the light is dispersed into the air layer 13 of the empty space. Accordingly, the screen 7 is illuminated at a substantially uniform illuminance. When a size of the screen 7 is small and the backside of the screen 7 is processed to be a surface capable of easily reflecting light as in a specular surface (or polished surface), the plate of the screen-supporting transparent acrylic 15 cannot be used.

If the backside reflection wall 14 is configured to be inclined toward the screen 7 in the upward direction as shown in FIG. 15, an amount of light reflected in a direction from the backside reflection wall 14 to the screen 7 increases and the illuminance of the screen 7 is bright. If the screen 7 and the backside reflection wall 14 are installed in parallel, some converging light returns to the transparent material flat board fragment set 1, 1′ of the empty space by a reflection plate 5 installed in a side section portion located in the upward direction, such that the screen 7 is more brightly illuminated while the reflection and transmission are repeated.

On the other hand, the controller 4 controls the lens-type LEDs assigned to spaces 23 of the transparent material flat board fragment set 1, 1′ of this embodiment in which the space separation partition walls 16 are installed such that a light turn-on sequence and/or a hue variation sequence vary in various flow patterns. Therefore, there are shown the dynamic effect of an illumination variation of the respective spaces 23 as if water is flowing, and the dynamic effect of a variation of an illuminated portion on the light transmission screen 7 installed in the front side as if water is flowing.

This embodiment has a feature in that it can provide a screen device of a side sectional illumination method without configuring a transparent material flat board fragment set using a heavy expensive material. Moreover, this embodiment causes light illuminating the respective spaces to be limited therein by installing the plurality of space separation partition walls 16. The dynamic screen effect is exhibited by controlling the light turn-on sequence and the hue variation sequence of the illuminating lights illuminating only the respective spaces 23 under the control of the controller 4.

### Embodiment 5

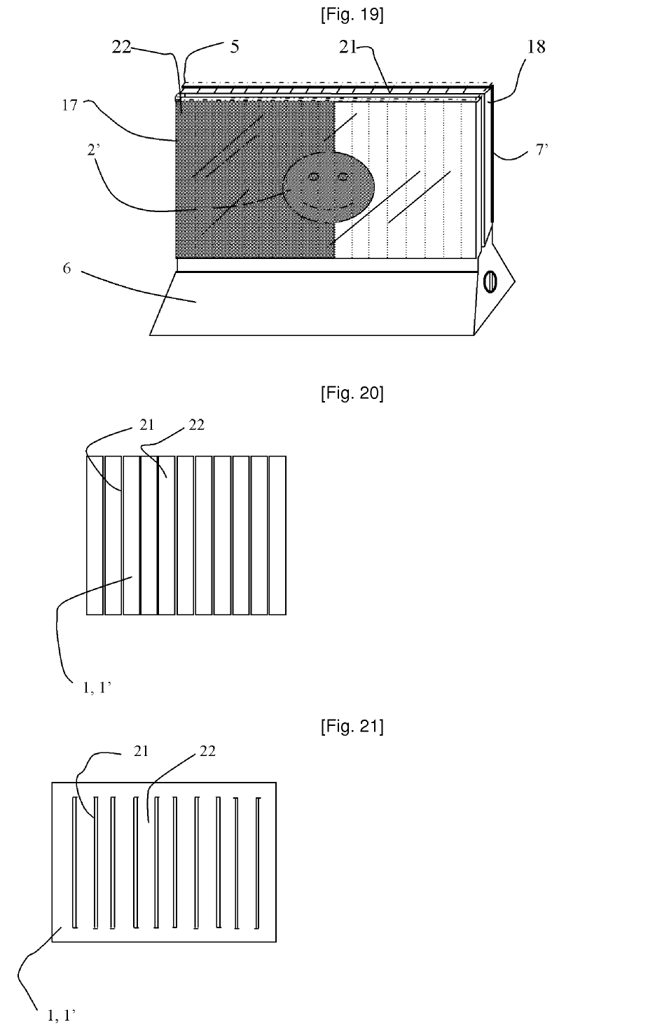

This embodiment is another embodiment of the present invention in which a multiscreen device is configured by installing and configuring a front screen device 17 on which an image 2′ for a front screen of FIG. 19 is arranged in the form of a character or pattern in front of the screen device of Embodiment 1 (FIG. 1), the screen device of Embodiment 2 (FIG. 7), the screen device of Embodiment 3 (FIG. 13), or the screen device of Embodiment 4 (FIG. 14) such that the two screen devices are overlapped as shown in FIGS. 18 and 19. A transparent material flat board fragment set 1, 1′ used in this embodiment is configured as shown in FIG. 20 or 21.

That is, a rear screen device 18 of the two overlapped screen devices of FIG. 18 can be configured with one of the screen device of Embodiment 1 (FIG. 1), the screen device of Embodiment 2 (FIG. 7), the screen device of Embodiment 3 (FIG. 13), and the screen device of Embodiment 4 (FIG. 14). In the front screen device 17 serving as one of the two overlapped screen devices, the image 2′ configured with a character or pattern on a transparent material flat board (for example, transparent acrylic) surface is arranged and configured in a printing method, a mechanical sculpturing method, or a method of attaching a color sheet. When the image 2′ is arranged on a front side flat surface of the transparent material flat board for the front screen device in the printing method or the method of attaching the attachment sheet, the print ink or attachment sheet is configured with a material having a light transmission semi-transparent characteristic. When an image 2′ is arranged and configured on the backside flat surface of the transparent material flat board for the front screen device in the printing method or the method of attaching the attachment sheet, an opaque material can be used.

An illuminating light device 3 used in this embodiment is installed and configured by parallel arranging an LED array 3 for illuminating the rear screen device 18 of the two overlapped screens and an LED array 3 for illuminating the front screen device 17 on one printed circuit board (PCB). As shown in FIG. 18, a light shield separation wall 20 installed between the two LED arrays 3 is configured to prevent light of the LED array 3 of the rear screen device 18 from affecting the front screen device 17 or prevent light of the LED array 3 of the front screen device 17 from affecting the rear screen device 18. The LED array 3 for the rear screen device 18 is configured to be controlled by the controller 4 as if a flow of an LED turn-on sequence or an LED hue variation sequence moves.

When the LED array 3 for the front screen device 17 is designed such that the hue of the image 2′ of the front screen device 17 varies, the variable color illuminating device 3 illuminates, such that illuminating light sequentially varying in a programmed sequence is controlled to simultaneously illuminate the overall front screen device 17.

The image 2, 2′ arranged in the front screen device 17 or the rear screen device 18 is configured in a plurality of hues and illuminating lights for illuminating the image 2′, 2 are configured to be variable in a plurality of hues. According to hue variation of the illuminating lights, light is emitted from the image 2, 2′ having the same hue as that of the illuminating light among the images 2, 2′ of multiple hues, such that an image portion from which light is emitted can be differently configured.

If the light is desired to be emitted in one fixed hue without requiring a hue variation of the image 2′ of the front screen device 17, LEDs of the front screen device 17 can be configured in one hue without the controller.

One PCB on which the two LED arrays 3 are unified is embedded and installed in a base (case) 6 of FIG. 18. The controller 4 configured with a microcomputer is installed and configured on the PCB. The transparent material flat board for the front and rear screen devices 17, 18 and the transparent material flat board fragment set 1, 1′ for the rear screen device 18 are simultaneously supported and fixed.

An operation of this embodiment configured as described above will be described in detail with reference to an example in which the screen device of FIG. 13 (Embodiment 3) is coupled as the rear screen device 18.

As described with reference to Embodiment 3 (FIG. 13), the rear screen device 18 operates while giving an effect that an illumination state of a screen moves in a programmed sequence under the control of the controller 4 as if water is flowing and as such simultaneously produces a dynamic effect of a screen. On the other hand, the light is emitted from the image 2′ of the front screen device by the illuminating light of the LED array 3 for the front screen device illuminating only the front screen device 17 with a feeling that the image 2′ arranged on the front screen device 17 is in a static state. The reason why the dynamic feeling is not in the image 2′ of the front screen device is that the front screen device 17 is not configured with the transparent material flat board fragment set 1, 1′.

If the LED array 3 for the front screen device is configured to illuminate in a variable color, the hue of the image 2′ arranged and configured on the front screen device 17 is variable at a regular time interval and light is emitted from the image 2′.

Accordingly, when the screen device of this embodiment, in which the front screen device 2′ and the rear screen device 18 are coupled in an overlap state, is viewed from the front side, one screen image is expressed by combining two types of screen devices. That is, a dynamic screen effect of the rear screen device 18 is viewed in a background screen moving behind the image 2′ from which light is emitted with a feeling that the front screen device 17 is static state as shown in FIG. 19. An example in which the screen device of FIG. 13 is used as the rear screen device 18 has been described so far. This is only illustrative, and actually the screen device of FIG. 1, the screen device of FIG. 7, or the screen device of FIG. 14 can be used as the rear screen device.

If the image 2′ of the front screen device 17, the image 2 of FIG. 1 arranged on the rear screen device 18, or the picture of the backside attaching screen 7′ used for the rear screen device 18 is configured in a plurality of types of hues and the illuminating lights of the illuminating light device 3 for illuminating the front screen device 17 or the rear screen device 18 are configured to be variable in a plurality of hues, light is emitted from only a portion having the same light hue as illuminating light among the pictures of many hues expressed in the image 2 of the rear screen device 18, or the backside attaching screen 7′ of the rear screen device 18 according to hue variation of the illuminating lights, thereby producing the screen effect of various designs. That is, for example, three types of pictures or images respectively expressed in Red (R), Green (G) and Blue (B) hues are expressed on the backside attaching screen 7′ or the image 2′, 2, and illuminating light variable in R, G and B illuminates in the side section. In this case, when illuminating light of R illuminates, light is emitted from only an R hue portion in the pictures or images of the screen. When illuminating light of G illuminates, light is emitted from only a G hue portion in the pictures or images of the screen. When illuminating light of B illuminates, light is emitted from only a B hue portion in the pictures or images of the screen. Accordingly, it is possible to produce the screen effect variable in various hues and expressions based on a hue variation of the illuminating light.

In the configuration embodiments of the present invention described so far, there has been described an example in which the illuminating light device 3 configured with a plurality of illuminating lights is installed only in a side section of a lower end portion. However, this is only illustrative and both the illuminating light devices 3 can be installed facing each other in side sections of upper and lower ends so as to brightly increase the illuminance of a screen when a width of the screen device is very large. In this case, the illuminating light device 3 installed in the side section of the upper end and the illuminating light device 3 installed in the side section of the lower end can be configured to be controlled by one controller. In another method, controllers can be respectively provided for the upper and lower illuminating light devices and two controllers 4 for controlling the two upper and lower illuminating light devices can be configured to operate in synchronization with each other.

When the respective controllers 4 are provided in the two illuminating light devices 3 in the upper and lower side sections, the controller 4 installed in one of the two upper and lower illuminating light devices 3 is configured to output a synchronization signal at a regular time interval. The controller 4 of the other illuminating light device 3 receives the output synchronization signal and operates in synchronization with the signal, such that the two upper and lower illuminating light devices are synchronized with each other.

In another control method, the upper and lower illuminating light devices are intentionally configured not to operate in synchronization with each other. Illuminating light incident from the illuminating light device 3 installed in the upper side section is combined with that incident from the illuminating light device 3 installed in the lower side section and illuminating patterns are produced while producing mutual interference due to a phase difference. Consequently, the respective illuminating patterns of the upper and lower illuminating light devices are combined and a flow of various illuminating patterns based on the mutual interference is produced and shown on the screen of the screen device.

When the illuminating lights to be controlled by the controller are controlled to be turned on/off in the configurations and operations of Embodiments 1, 2, 3, 4, and 5 of the present invention described so far, it looks as if a bright portion of an illuminated screen moves. When the controller controls a hue variation sequence of the illuminating lights to control a hue variation, it looks as if a flow of the hue variation moves. That is, for example, when the illumination hues of the illuminating lights are varied in a direction from the left to the right, the screen effect exhibits the hue variation as if water is flowing from the left to the right. The hue variation of the illuminating light can be controlled using a variable color LED from which light can be emitted in many hues. In another method, LEDs of three hues from which light of single colors of R, G, and B are emitted are assigned to a side section of each transparent material flat board fragment set 1, 1′. The LEDs can illuminate to be variable in many hues by causing the controller to turn on the LEDs in a sequential combination of R, G, B, R-G, G-B, or B-R.

The reflection plate 5 installed in a side section portion facing that in which the illuminating light device is installed can be configured with a reflection sheet. When a design is required to emit light from the remaining three side section portions without the illuminating light device of the screen device, the reflection plate 5 can be omitted. Moreover, when the respective illuminating light devices are installed in the upper and lower side sections, the reflection plate 5 is not installed.

1. A screen device of a side sectional illumination method for producing an image emitting effect in a transparent material flat board screen device in which an illuminating light is installed in a side section of transparent acrylic and an image is arranged on a flat surface portion of the transparent acrylic, comprising:
a transparent material flat board fragment set (1, 1′) configured with a set of transparent material flat board fragments (22) having a regular width;
a light emitting diode array (3) installed and configured such that a controller (4) configured with a microcomputer in one side section portion of the transparent material flat board fragment set (1, 1′) controls a light turn-on sequence and/or a hue variation sequence based on content programmed in advance, the light emitting diode array (3) being configured with a plurality of light emitting diodes in the side section portion located in a direction perpendicularly meeting fragment separation lines (21) for separating the transparent material flat board fragments (22) of the transparent material flat board fragment set (1, 1′);
a portion of an image (2) from which light is emitted is arranged and configured on one side flat surface of the transparent material flat board fragment set (1, 1′) using one of a printing method, a mechanical sculpturing method, and a method of attaching a color sheet on which a transparent adhesive is coated; and
a case (base) (6) in which the light emitting diode array (3) and the controller (4) are embedded, the case (6) supporting and fixing the transparent material flat board fragment set (1, 1′),
wherein the effect is produced as if the portion of the image (2) from which the light is emitted moves by controlling the light turn-on sequence and/or the hue variation sequence of the light emitting diode array (3).

2. A screen device of a side sectional illumination method for producing an image emitting effect in a transparent material flat board screen device in which an illuminating light is installed in a side section of transparent acrylic and an image is arranged on a flat surface portion of the transparent acrylic, comprising:
a transparent material flat board fragment set (1, 1′) configured with a set of transparent material flat board fragments (22) having a regular width;
a light emitting diode array (3) installed and configured such that a controller (4) configured with a microcomputer in one side section portion of the transparent material flat board fragment set (1, 1′) controls a light turn-on sequence and/or a hue variation sequence based on content programmed in advance, the light emitting diode array (3) being configured with a plurality of light emitting diodes in the side section portion located in a direction perpendicularly meeting fragment separation lines (21) for separating the transparent material flat board fragments (22) of the transparent material flat board fragment set (1, 1′), an overall surface of each transparent material flat board fragment (22) of the transparent material flat board fragment set (1, 1′) being configured to be surface-emitting in one side flat surface of the transparent material flat board fragment set (1, 1′) using one of a printing method, a mechanical sculpturing method, and a method of attaching a color sheet on which a transparent adhesive is coated;
a reflection sheet (9) installed and configured in a backside of a surface-emitting portion;
a screen (7) printed on a light transmission material in the front portion of the transparent material flat board fragment set (1, 1′); and
a case (for example, base) (6) in which the light emitting diode array (3) and the controller (4) are embedded, the case (6) supporting and fixing the transparent material flat board fragment set (1, 1′) and the screen (7),
wherein light emissions of the surface-emitting transparent material flat board fragments (22) of the transparent material flat board fragment set (1, 1′) are controlled in a programmed sequence, such that the effect is produced as if a portion illuminated on the screen (7) installed in the overall surface of the transparent material flat board fragment set (1, 1′) moves.

3. A screen device of a side sectional illumination method for producing an image emitting effect in a transparent material flat board screen device in which an illuminating light is installed in a side section of transparent acrylic and an image is arranged on a flat surface portion of the transparent acrylic, comprising:
a transparent material flat board fragment set (1, 1′) configured with a set of transparent material flat board fragments (22) having a regular width;
a light emitting diode array (3) installed and configured such that a controller (4) configured with a microcomputer in one side section portion of the transparent material flat board fragment set (1, 1′) controls a light turn-on sequence and/or a hue variation sequence based on content programmed in advance, the light emitting diode array (3) being configured with a plurality of light emitting diodes in the side section portion located in a direction perpendicularly meeting fragment separation lines (21) for separating the transparent material flat board fragments (22) of the transparent material flat board fragment set (1, 1′), a backside screen (7′) printed to be attached on a backside flat surface of the transparent material flat board fragment set (1, 1′) attached using a transparent adhesive (10) in a state in which an air layer is excluded, a printed portion of the backside screen (7′) being configured to be attached to a backside of the transparent material flat board fragment set (1, 1′); and
a case (for example, base) in which the light emitting diode array (3) and the controller (4) are embedded, the case supporting and fixing the transparent material flat board fragment set (1, 1′),
wherein the dynamic effect is produced as if a light-emitting portion of the backside attaching screen (7′) attached to the backside of the transparent material flat board fragment set (1, 1′) moves when the controller (4) controls the light emitting diode array (3).

4. A screen device of a side sectional illumination method for producing an image emitting effect in a transparent material flat board screen device in which an illuminating light is installed in a side section of transparent acrylic and an image is arranged on a flat surface portion of the transparent acrylic, comprising:
a transparent material flat board fragment set (1, 1′) configured by installing a plurality of space separation partition walls (16) having a function of limiting illuminating light within respective spaces (23) at regular intervals in a transparent material flat board configured with an air layer (13) of an empty space formed by a backside reflection wall (14) installed to be in parallel with a plate of a screen-supporting transparent acrylic (15) on which a screen (7) of a light transmission material is installed and the screen (7) or to be inclined;
an illuminating light device (3) configured with a lens-type light emitting diode array (3) for radiating converging light in a front side portion in which a convex lens is configured in one side section portion of the transparent material flat board fragment set (1, 1′) configured with the empty-space air layer (13) located in a direction perpendicularly meeting the plurality of space separation partition walls (16), the lens-type light emitting diode arrays (3) being configured such that a controller (4) controls a light turn-on sequence and/or a hue sequence; and
a case (for example, base) (6) in which the light emitting diode array (3) and the controller (4) are embedded, the case (6) supporting and fixing the screen (7) and the backside reflection wall (14),
wherein the light is dispersed while the converging light radiated from the light emitting diode array (3) is repeatedly reflected between the backside of the screen (7) and the backside reflection wall (14) and is repeatedly transmitted to the screen (7), and simultaneously a portion illuminated on the screen moves when the controller (4) controls an illumination sequence of the respective spaces (23).

5. A screen device of a side sectional illumination method for producing an image emitting effect in a transparent material flat board screen device in which an illuminating light is installed in a side section of transparent acrylic, an image is arranged on a flat surface portion of the transparent acrylic, and one screen device is configured by overlapping two transparent acrylic screen devices, comprising:
a transparent material flat board fragment set (1, 1′) configured in a form in which a plurality of transparent material flat board fragments (22) are combined;
a rear screen device (18) configured using the transparent material flat board fragment set (1, 1′);
a front screen device (17) installed and configured to be overlapped with the rear screen device (18) serving as another transparent material flat board screen device on which an image (2′) is arranged in front of the rear screen device (18), an image (2′) of the front screen device (17) being arranged and configured in one of a printing method, a mechanical sculpturing method, and a method of attaching a color sheet on which a transparent adhesive is coated;
a screen means of the rear screen device (18) configured with one screen device of one of the devices of claims 1, 2, 3, and 4;
illuminating light devices (3) configured with two light emitting diode arrays (3) respectively illuminating the rear screen device (18) and the front screen device (17), the illuminating light devices (3) being installed and configured in a side section in an identical direction of the rear screen device (18) and the front screen device (17); and
a light shield separation wall (20) installed between the two light emitting diode arrays (3) to prevent light from illuminating an undesired position,
wherein a dynamic screen effect is produced in the rear screen device (18) when a controller (4) controls the illuminating light devices (3), light of the image of the front screen device (17) is emitted in a single color or a variable color, a case (for example, base) (6) in which the illuminating light devices (3) configured with the two light emitting diode arrays (3) and the controller (4) are embedded and the rear screen device (18) and the front screen device (17) are simultaneously supported and fixed, and a new screen is produced by mutually overlapping a background screen serving as a screen of the dynamic effect of the rear screen device (18) behind the image (2′) of the front screen device (17).

6. The screen device of the side sectional illumination method for producing the dynamic effect according to any one of claims 1 to 5, wherein the illuminating light devices (3) are installed facing each other in side section portions of two positions located in a direction perpendicularly meeting fragment separation lines (21) for separating the transparent material flat board fragments (22) of the transparent material flat board fragment set (1, 1′), the two illuminating light devices (3) being configured to operate in synchronization with each other.

7. The screen device of the side sectional illumination method for producing the dynamic effect according to any one of claims 1 to 5, wherein the illuminating light devices (3) are installed facing each other in side section portions of two positions located in a direction perpendicularly meeting fragment separation lines (21) for separating the transparent material flat board fragments (22) of the transparent material flat board fragment set (1, 1′), the two illuminating light devices (3) being configured to operate in non-synchronization with each other.
